(19) United States
(12) Patent Application Publication
(10) Pub. No.: US 2022/0343704 A1
(43) Pub. Date: Oct. 27, 2022

(54) STORE CHANNEL PRESTAGING AND CUSTOMER INTERACTION

(71) Applicant: Wells Fargo Bank, N.A., San Francisco, CA (US)

(72) Inventors: Miranda C. Hill, Seattle, WA (US); Marria Rhodriquez, San Francisco, CA (US); Dominik Vltavsky, Belmont, CA (US); Nancy B. Zimmerman, Fairfax, CA (US)

(21) Appl. No.: 15/794,460

(22) Filed: Oct. 26, 2017

Related U.S. Application Data
(60) Provisional application No. 62/417,870, filed on Nov. 4, 2016.

(51) Int. Cl. G07C 9/00; G06Q 10/02; G06Q 10/10; G06Q 20/32; H04W 4/02; G06Q 40/02

(52) U.S. Cl. CPC G07C 9/00126; G06Q 10/02; G06Q 10/1095; G06Q 20/3221; G06Q 20/3227; H04W 4/02; G06Q 40/02

(57) ABSTRACT

Examples described herein relate to apparatus and methods for a user to exchange information with a financial institution computing system (a branch location thereof) via a user device before the user is service, including, but not limited to, determining that the user device is present at the branch location of the financial institution, and in response to determining that the user device is present at the branch location, performing one or more of displaying information related to service at the branch location or displaying information unrelated to service at the branch location.

### CROSS-REFERENCE TO RELATED APPLICATION

This application claims priority to U.S. Provisional Patent Application No. 62/417,870 entitled “STORE CHANNEL PRESTAGING AND CUSTOMER INTERACTION,” filed Nov. 4, 2016, and incorporated herein by reference in its entirety.

### BACKGROUND

Customers visiting a location (e.g., a branch location) of a financial institution may experience at least some level of wait time until being serviced by an employee (e.g., a teller, personal banker, business banker, loan officer, financial advisor, or the like) of the financial institution. Traditionally, customer interaction during the wait time is limited to an employee greeting the customers as they enter the branch location.

### SUMMARY

Examples described herein relate to apparatus and methods for enhancing customer in-store experience while a customer waits to be serviced by bank staff at a branch location of a financial institution. Particularly, a mobile application on a user device presents information to the customer and/or obtaining input from the customer in response to determining that the customer (e.g., the user device) is present in a branch location of the financial institution. The information presented to the customer and/or the user input obtained from the customer includes, but not limited to, information related to service at the branch location that the customer presently requests, information unrelated to any requested service at the branch location, and the like. For instance, the information related to the service includes prestaging information (e.g., type of requested service, customer information, customer contact information, or the like) that can be used to assist bank staff in rending the service requested by the customer, wait time indication, scheduling information, customer feedback, authentication, or the like. In some instances, the information unrelated to the requested service includes charitable contributions by the financial institution, mobile-application games with themes associated with the financial institution and/or the branch location, financial profile information of the customer, discounts for the customer, financial health advices for the customer, or the like.

Generally, the information exchanged with the customer can improve productivity relative to the service being or about to be rendered by the branch location. This advantage is especially pronounced when information related to the service is being exchanged before the service because such information can inform the customer aspects of the service (e.g., wait time, position in queue, availability of staff, or the like). Given that information (e.g., customer profile, authentication, service selection, or the like) related to the service can be extracted from the customer before the actual service, additional gathering of such information during the service is no longer needed, thus saving time. The mobile application can further educate the customer about financial choices and the community during the wait period. Accordingly, arrangements as described herein can bridge the gap between a customer's in-store physical experience and digital experience, thus improving efficiency of the service requested by the customer while enhancing customer relations.

### BRIEF DESCRIPTION OF THE FIGURES

FIG. 1 is a diagram of an example of a system for enabling digital in-store experience according to some arrangements.

FIG. 2 is a diagram of a user device and a financial institution in the system set forth in FIG. 1 according to some arrangements.

FIG. 3 is a flow diagram illustrating a method for enabling digital in-store experience according to various arrangements.

FIG. 4 is a flow diagram illustrating a method for enabling digital in-store experience according to various arrangements.

FIGS. 5A-5B are diagrams of display user interfaces outputted by an input/output circuit of a user device for setting up an in-store mode according to various arrangements.

FIG. 5C is a diagram of a display user interface outputted by an input/output circuit for notifying a user that the user is at a branch location according to various arrangements.

FIG. 6 is a diagram of a display user interface outputted by an input/output circuit of a user device according to various arrangements.

FIGS. 7A-7C are diagrams of display user interfaces outputted by an input/output circuit of a user device for exchanging information related to the service at a branch location according to various arrangements.

FIGS. 8A-8E are diagrams of display user interfaces outputted by an input/output circuit of a user device for exchanging information unrelated to the service at a branch location according to various arrangements.

FIGS. 9A-9D are diagrams of display user interfaces outputted by an input/output circuit of a user device for exchanging information unrelated to the service at a branch location according to various arrangements.

FIGS. 10A-10F are diagrams of display user interfaces outputted by an input/output circuit of a user device for exchanging information unrelated to the service at a branch location 110 (FIG. 1) according to various arrangements.

FIGS. 11A-11C are diagrams of display user interfaces outputted by the input/output circuit of the user device for exchanging information unrelated to the service at an branch location according to various arrangements.

### DETAILED DESCRIPTION

Referring generally to the FIGS., methods, apparatus, and non-transitory medium are set forth herein for enhancing a customer's in-store experience at a branch location of a financial institution by adding a digital component that improves a physical component of the experience. Particularly, a user device of the customer can determine that the customer (the user device) is present in the branch location through one or more of Global Positioning System (GPS), cell tower triangulation, Wireless Fidelity (Wi-Fi) Positioning System (WPS), or another suitable positioning mechanism. Upon determining that the customer is present in the branch location, the user device is capable of displaying information and/or receiving user input for information related to at least one requested service at the branch location and/or information unrelated to the requested service at the branch location.

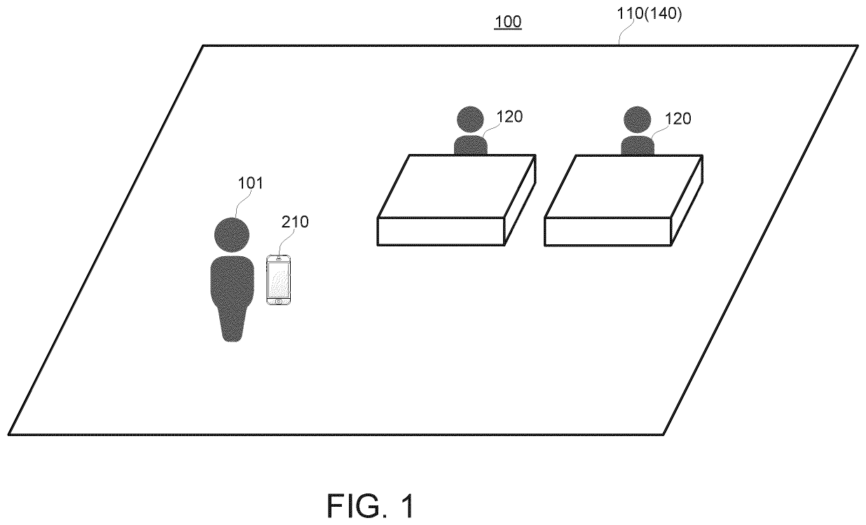

FIG. 1 is a diagram of an example of a system 100 for enabling digital in-store experience according to some arrangements. Referring to FIG. 1, a user 101 is a customer or potential customer of a financial institution 140. The user 101 can be any of individuals, business representatives, large and small business owners, and any other entity having or expected to have a business relationship with the financial institution 140. In some configurations in which the user 101 is a customer of the financial institution 140, the user 101 has at least one financial account at the financial institution 140. In other configurations are concerned with the user 101 being a potential customer of the financial institution 140.

In some scenarios, the user 101 is present in a branch location 110 of the financial institution 140 for obtaining services rendered by the branch location 110 (and the financial institution 140). The branch location 110 can be a bank branch, loan office, mortgage office, financial services office, retail office, Automatic Teller Machine (ATM) location, a combination thereof, and/or the like. The branch location 110 is staffed by one or more employees 120 that can serve the user 101 in some suitable financial practices. Examples of the employees 120 include, but not limited to, tellers, personal bankers, business bankers, loan officers, financial advisors, or the like. In some arrangements, the branch location 110 is entirely automated (e.g., the branch location 110 has ATMs and/or other machines/devices that automatically serve the user 101).

The user 101 has a user mobile device 210 (e.g., a smart phone). As the user 101 enters the branch location 110, the user device 210 also enters the branch location 110. Thus, a location of the user device 210 can define a location of the user 101. The user device 210 performs various functions described herein with respect to displaying information and/or receiving user input corresponding to information related to the requested service at the branch location and/or information unrelated to the requested service at the branch location in the manner described.

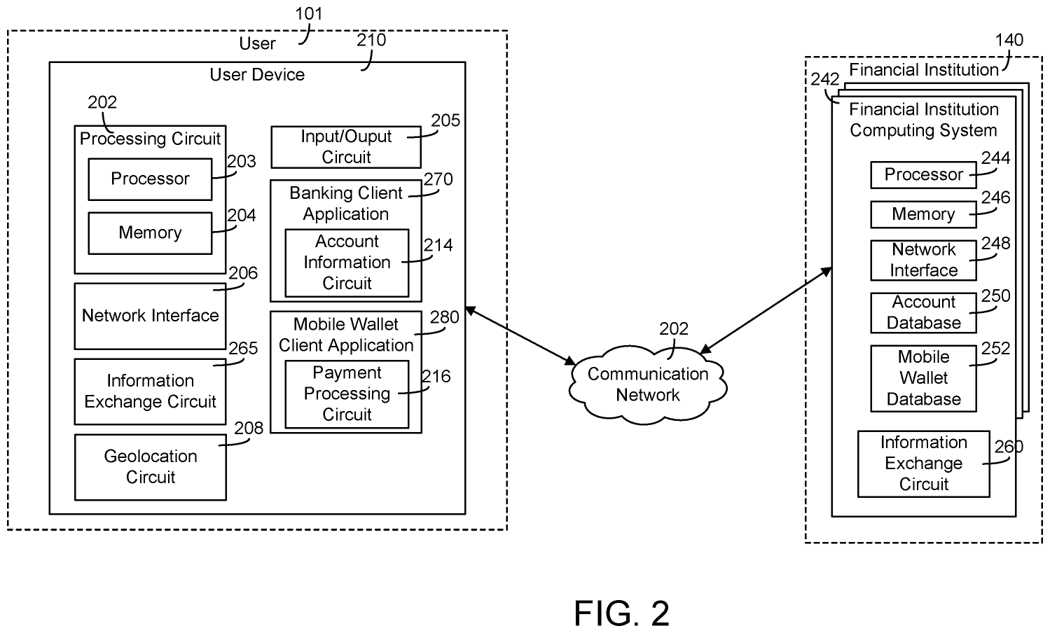

FIG. 2 is a diagram of an example of the user device 210 and an example of the financial institution 140 in the system 100 set forth in FIG. 1 according to some arrangements. Referring now to FIGS. 1-2, the financial institution 140 has at least one associated financial institution computing system 242. In some configurations, the financial institution computing system 242 is located in the branch location 110 and/or can be used by the employees 120 to provide services to the user 101. In other configurations, the financial institution computing system 242 is located at a location other than the branch location 110. In such configurations, an additional computing system such as, but not limited to, the financial institution computing system 242 can be provided to the branch location 110 for communicating with one or both of the user device 210 or the financial institution computing system 242.

The user device 210 and the financial institution computing system 242 are communicably and operatively coupled to each other over a communication network 202. The communication network 202 is any suitable Local Area Network (LAN) or Wide Area Network (WAN). For example, the communication network 202 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The network 202 is structured to permit the exchange of data, values, instructions, messages, and the like among the user device 210, the financial institution computing system 242, and another suitable computing system at the branch location 110.

As shown, the financial institution 140 provides financial products and services such as, but not limited to, credit cards, checking/saving accounts, retirement accounts, mortgages, loans, investment and financial accounts, and the like to the user 101 via the financial institution computing system 242 and/or another suitable computing system at the branch location 110. The financial institution computing system 242 includes a processor 244 and a memory device 246. The processor 244 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 246 is or includes tangible, non-transient volatile memory or non-volatile memory. In this regard, the memory 246 stores programming logic that, when executed by the processor 244, controls the operations of the financial institution computing system 242.

As shown, the financial institution computing system 242 includes a network interface 248. The network interface 248 is structured for sending and receiving of data over the network 202 (e.g., to and from the user device 210, etc.). Accordingly, the network interface 248 includes any of a cellular transceiver (for cellular standards), local wireless network transceiver (for 802.11X, ZigBee, Bluetooth, Wi-Fi, or the like), wired network interface, combination thereof (e.g., both a cellular transceiver and a Bluetooth transceiver), and/or the like.

The financial institution computing system 242 includes an account database 250 that stores customer information and account information relating to one or more accounts held by the user 101 with the financial institution 140. In this regard and as mentioned, more than one financial institution (such as, but not limited to, the financial institution 140) with an associated financial institution computing system (such as, but not limited to, the financial institution computing system 242) can be communicably coupled to the components of FIG. 2 over the communication network 202 to access the accounts held by the user 101. The financial institution computing system 242 includes a mobile wallets account database 252 for storing mobile wallet accounts of users, including the user 101. As described herein, the mobile wallet accounts permit payments via a mobile wallet client application 280 of the user device 210.

The financial institution computing system 242 includes an information exchange circuit 260. The information exchange circuit 260 is operatively coupled to the components of the financial institution computing system 242 and is capable of exchanging information with the user device 210. For example, the information exchange circuit 260 is coupled to the network interface 248 for communicating with the user device 210 via the communication network 202. The information exchange circuit 260 is coupled to one or more of the account database 250 or mobile wallet database 252 to access information stored thereon or store additional information provided by the user 101 of the user device 210. In some examples, the information exchange circuit 260 is implemented within the processor 244. For example, the information exchange circuit 260 is implemented as a software application stored within the memory 246 and executed by the processor 244. Accordingly, such examples can be implemented with minimal or no additional hardware costs. However, other implementations rely on dedicated hardware specifically configured for performing operations of the information exchange circuit 260.

As shown, the user 101 operates or is associated with the user device 210. In some arrangements, the user device 210 is a mobile device. The mobile device includes any wearable device. Wearable devices refer to any type of device that the user 101 can wear, including, but not limited to, a watch (e.g., a smart watch), glasses (e.g., eye glasses, sun glasses, smart glasses, etc.), bracelet (e.g., a smart bracelet), etc. The user device 210 may be a computing device including, but not limited to, a phone (e.g., a smartphone, etc.) and a computing device (e.g., a tablet computer, a laptop computer, a person digital assistant, etc.). In some arrangements, the user device 210 is a computing device such as, but not limited to, a desktop computer, server, or other types of computing device. Accordingly, the user device 210 includes a display device (e.g., a screen) and one or more input/output devices (e.g., a touch screen, microphone, speaker, keyboard, etc.), collectively referred to as an input/output circuit 205 for receiving user input from the user 101 and/or outputting information to the user 101.

In some arrangements, the user device 210 includes a processing circuit 202 having a processor 203 and memory 204. The processor 203 is implemented as a general-purpose processor, an ASIC, one or more FPGAs, a DSP, a group of processing components that are distributed over various geographic locations or housed in a single location or device, or other suitable electronic processing components. The memory 204 (e.g., RAM, NVRAM, ROM, Flash Memory, hard disk storage, etc.) stores data and/or computer code for facilitating the various processes described herein. Moreover, the memory 204 is or includes tangible, non-transient volatile memory or non-volatile memory. Accordingly, the memory 204 includes database components, object code components, script components, or any other type of information structure for supporting the various activities and information structures described herein.

The user device 210 is shown to include various circuits and logic for implementing the activities described herein. More particularly, the user device 210 includes one or more of an input/output circuit 205, network interface 206, mobile wallet client application 280, banking client application 270, information exchange circuit 265, and geolocation circuit 208. While various circuits, interfaces, and logic with particular functionality are shown, it should be understood that the user device 210 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included, etc.

The network interface 206 is configured for and structured to establish a communication session via the network 202 with the financial computing system 142. Accordingly, the network interface 206 is an interface such as, but not limited to, the network interface 248.

The input/output circuit 205 is configured to receive user input from and provide information to the user 101. In this regard, the input/output circuit 205 is structured to exchange data, communications, instructions, etc. with an input/output component of the device 210. Accordingly, in some arrangements, the input/output circuit 205 includes an input/output device such as a display device, touchscreen, keyboard, microphone, and/or the like. In some arrangements, the input/output circuit 205 includes communication circuitry for facilitating the exchange of data, values, messages, and the like between the input/output device and the components of the user device 210 (e.g., the information exchange circuit 265). In some arrangements, the input/output circuit 205 includes machine-readable media for facilitating the exchange of information between the input/output device and the components of the user device 210 (e.g., information exchange circuit 265). In still another arrangement, the input/output circuit 205 includes any combination of hardware components (e.g., a touchscreen), communication circuitry, and machine-readable media.

One or more of the information exchange circuit 265, banking client application 270, or mobile wallet client application 280 are server-based applications executable on the user device 210. In this regard, the user 101 has to first download the application(s) prior to usage. In another arrangement, the information exchange circuit 265, banking client application 270, and/or mobile wallet client application 280 are coded into the memory 204 of the user device 210. In still another arrangement, the information exchange circuit 265, banking client application 270, and/or mobile wallet client application 280 are web-based interface applications. In this configuration, the user 101 has to log onto or access the web-based interface before usage. In this regard, at least one of the information exchange circuit 265, banking client application 270, and mobile wallet client application 280 is supported by a separate computing system comprising one or more servers, processors, network interface modules, etc. that transmit the applications for use to the user device 210. In certain arrangements, one or more of the information exchange circuit 265, banking client application 270, and/or mobile wallet client application 280 include an Application Programming Interface (API) and/or a Software Development Kit (SDK) that facilitate integration of other applications. All such variations and combinations are intended to fall within the spirit and scope of the present disclosure.

The banking client application 270 is communicably coupled to the financial institution computing system 242 (e.g., the account database 250) via the network 202 and is structured to permit management of at least one account of the user 101 via the banking client application 270. In this regard, the banking client application 270 provides displays indicative of account information such as, but not limited to, current account balances, pending transactions, profile information (e.g., contact information), reward associated with the account, bill pay information and/or the like. Further, in some arrangements, the banking client application 270 is configured to process payments from the user 101 to a designated recipient. For example, the banking client application 270 depicts a loan (e.g., mortgage) of the user 101 and allows the user 101 to pay the loan from an account (e.g., checking or savings). In some examples, a bill pay option is provided by the banking client application 270, where the bill pay option allows the user 101 to pay his/her bills in response to user input.

As mentioned herein, via the banking client application 270, the user 101 pays bills (e.g., mortgage, etc.), view balances, and otherwise manage their account. Accordingly and as shown, the mobile bank client application 270 includes an account information circuit 214. The account information circuit 214 is linked or otherwise coupled to one or more accounts (as stored the account database 250) held by the user 101 and permit management of the associated accounts (e.g., transfer balances between accounts, see payment history, etc.) by communicating with the financial institution computing system 242. The banking client application 270 is communicably coupled to the mobile wallet client application 280. As such, in response to a mobile payment via the application 280, the application 280 causes the banking client application 270 to update the payment account (i.e., the account that supported the mobile payment). As such, the mobile wallet and banking client applications 280 and 270 are communicably coupled to each other to enable actions supported by each respective application in some examples.

The mobile wallet client application 280 is communicably coupled to the financial institution computing system 242 (e.g., the mobile wallets database 252) via the communication network 202 and is structured to facilitate purchases by the user 101 via the mobile wallet client application 280. Accordingly, the mobile wallet client application 280 is linked or otherwise connected with one or more accounts (as stored the account database 250) of the user 101. In operation, when at a point-of-sale terminal, the user 101 initiates the mobile wallet client application 280 and provides a passcode (e.g., biometrics such as a thumbprint, a Personal Identification Number (PIN), a password, etc.) to authenticate the user 101 and select the source payment account desired (e.g., a checking account from a particular financial institution that is linked to the mobile wallet client application 280). Via communication with the payment terminal (e.g., via near field communication), the aforementioned payment information is provided and the payment processed. Beneficially, carrying payment cards are avoided or reduced via the mobile wallet client application 280.

As mentioned herein, the mobile wallet client application 280 is structured to facilitate and permit payments by interfacing with an account held by the user 101 at the financial institution 140. Accordingly, the mobile wallet client application 280 is communicably coupled via the network interface 206 over the communication network 202 to the financial institution computing system 242. As shown, the mobile wallet client application 280 includes a payment processing circuit 216 structured to facilitate payments by the user 101 via the mobile wallet client application 280. For example, the payment processing circuit 216 enables a quick-pay capability with a merchant. In this regard, the payment processing circuit 216 includes or be communicably coupled with a communication device (e.g., a near-field communication chip) that facilitates the exchange of information between the mobile wallet client application 280 and a point-of-sale terminal.

The information exchange circuit 265 is communicably coupled to the financial institution computing system 242 (e.g., the information exchange circuit 260) via the network 202 and is structured to facilitate exchange of information between the user 101 and the financial institution 140. For instance, the information exchange circuit 265 configures the input/output circuit 205 to output information received from the financial institution computing system 242 (e.g., the information exchange circuit 260) to the user 101. The information exchange circuit 265 configures the input/output circuit 205 to receive user input from the user 101 and send such information to the financial institution computing system 242 (e.g., the information exchange circuit 260). User interfaces provided by the information exchange circuit 265 are a part of user interfaces provided by the mobile wallet and banking client applications 280 and 270. Thus, the information exchange circuit 265 is communicably coupled to the mobile wallet and banking client applications 280 and 270 to enable actions supported by each respective application in some examples.

The geolocation circuit 208 includes hardware and/or software for determining a location of the user device 210, and therefore the location of the user 101. The geolocation circuit 208 includes one or more of a GPS radio for satellite positioning, Wi-Fi radio for Wi-Fi positioning, cellular radio for cell tower triangular, combinations thereof, or the like. Therefore, the geolocation circuit 208 can be implemented with or is operatively coupled to the network interface 206. The processing circuit 202 facilitates processing of the geolocation of the user device 210.

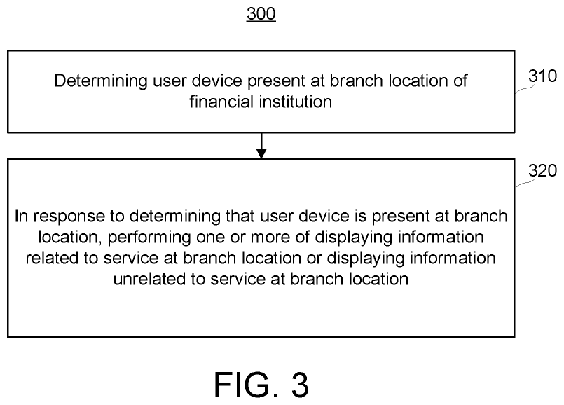

FIG. 3 is a flow diagram illustrating an example of a method 300 for enabling digital in-store experience according to various arrangements. Referring to FIGS. 1-3, the method 300 is generally concerned with presenting information to the user 101 while the user 101 is waiting at the branch location 110 for service. The method 300 is performed by at least the user device 210 (e.g., the information exchange circuit 265, the geolocation circuit 208, and the like) according to various arrangements.

At 310, the geolocation circuit 208 determines that the user device 210 is present at the branch location 110 of the financial institution 140. The location of the user device 210 represents the location of the user 101. The location of the user device 210 can be determined using one or more of GPS, cell tower triangulation, or WPS. The branch location 110 is defined by a boundary associated with an area of the branch location 110. Upon determining that the location of the user device 210 is within the boundary of the branch location 110, the user device 210 is present at the branch location 110.

At 320, in response to determining that the user device 210 is present at the branch location 110, the information exchange circuit 265 is capable of performing one or more of displaying information related to a service at the branch location 110 or displaying information unrelated to the service at the branch location. The service at the branch location 110 includes service requested or expected by the user 110. Upon entering the branch location 110, the user 101 may have to wait for an available employee (e.g., the employees 120) and/or an available machine (e.g., an ATM). Triggering an exchange of information upon determining that the user device 210 is present at the branch location 110 can allow the exchange of information to occur while the user 101 waits. The exchange of information includes receiving user input related to the service at the branch location 110 and/or unrelated to the service at the branch location 110 in some arrangements.

In some examples, the information related to the service at the branch location 110 or the information unrelated to the service at the branch location 110 is displayed before the service is actually rendered at the branch location 110. In some arrangements, the information exchange circuit 265 can determine whether the user 101 is being serviced based on an availability indication message received from the information exchange circuit 260 or based on another type of communication (e.g., a Short Messaging Service (SMS) message) indicating that the branch location 110 is ready to render service. In other arrangements, the user 110 can indicate, via the input/output circuit 205, that the user 110 is being serviced. Upon determination that the service is being rendered, the in-store mode (e.g., the displaying of the information related or unrelated to the service) is temporarily disabled until the service has been performed. In other arrangements, the in-store mode is not disabled while the user 101 is being serviced.

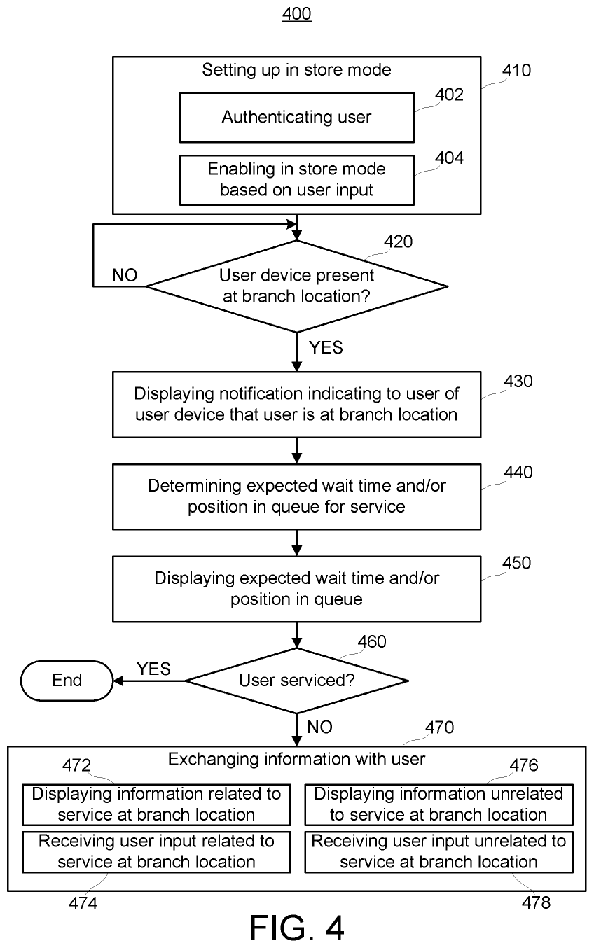

FIG. 4 is a flow diagram illustrating an example of a method 400 for enabling digital in-store experience according to various arrangements. Referring to FIGS. 1-4, the method 400 is an example of a particular implementation of the method 300 in some arrangements. Thus, each of one or more of 402-478 corresponds to each of 310 and 320. The method 400 is performed by at least the user device 210 (e.g., the information exchange circuit 265, the geolocation circuit 208, and the like) according to various arrangements.

At 410, the information exchange circuit 265 facilitates setting up an in-store mode. As described, the methods 300 and 400 can be implemented as an application (e.g., a mobile application, server/browser-based application, web-based application, and/or the like) on the user device 210. The in-store mode of the application is a platform for outputting information to the user 101 and/or receiving user input from the user 101. The in-store mode can be toggled based on preference of the user 101.

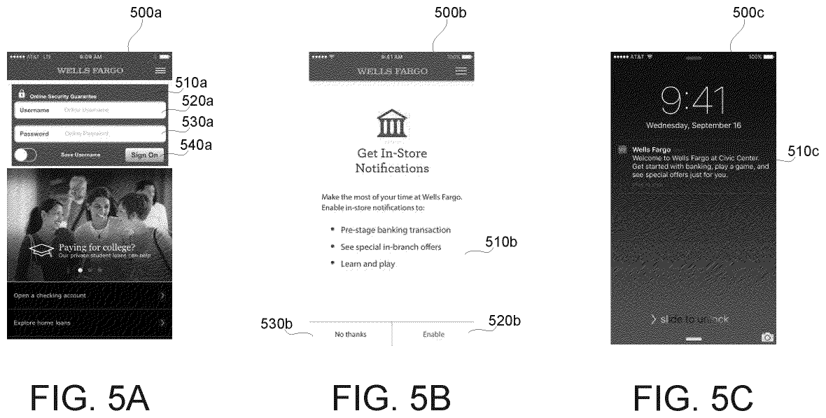

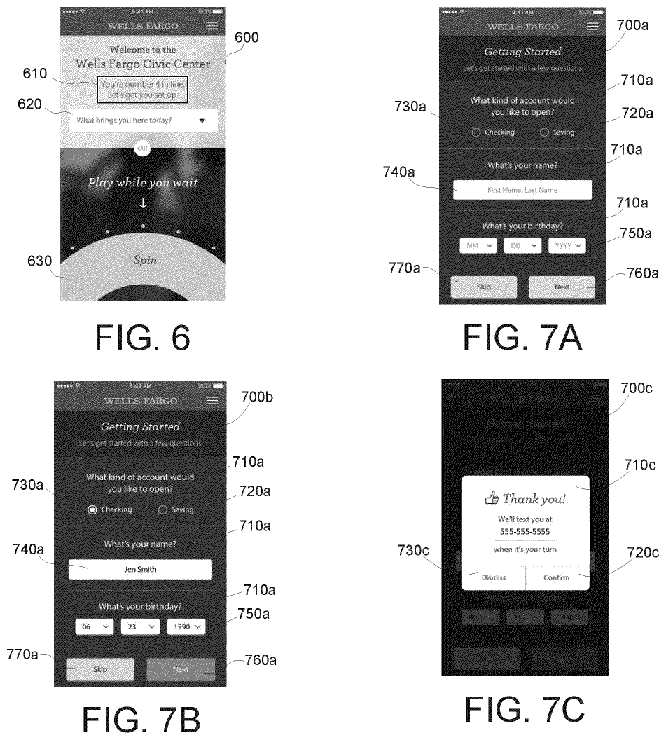

FIGS. 5A-5B are diagrams of display user interfaces 500a-500b outputted by the input/output circuit 205 (FIG. 2) of the user device 210 (FIG. 2) for setting up the in-store mode according to various arrangements. Referring now to FIGS. 1-5B, a user interface aspect of the information exchange circuit 265 facilitates presentation of the display user interfaces 500a-500b by the input/output circuit 205. In other arrangements, the banking client application 270 and/or the mobile wallet client application 280 can facilitate presentation of the display user interfaces 500a-500b by the input/output circuit 205 (i.e., the display user interfaces 500a-500b are parts of a banking client interface enabled by the banking client application 270 and/or a mobile wallet client interface enabled by the mobile wallet client application 280).

In some arrangements, setting up the in-store mode at 410 includes authenticating the user 101 at 402. Illustrating with a non-limiting example, the display user interface 500a can be used to authenticate the user 101. The display user interface 500a is displayed in response to the user 101 selecting, via the input/output circuit 205, to initialize the application. The application can be initialized upon the user 101 selecting a user interactive element presented by the input/output circuit 205 corresponding to initializing the application. The display user interface 500a includes a security interface 510a for authenticating the user 101. The security interface 510a has at least a user name field 520a, password field 530a, and sign-on element 540a. Upon the user 101 selecting the sign-on element 540a, credentials (corresponding to user input) in the user name field 520a and the password field 530a are evaluated. Other suitable authentication methods such as biometric authentications can be used.

In some arrangements, setting up the in-store mode at 410 includes enabling the in-store mode based on user input at 404. Illustrating with a non-limiting example, the display user interface 500b can be used to enable the in-store mode. After successful authentication via the display user interface 500a, the input/output circuit 205 presents the display user interface 500b. The display user interface 500b allows the user 101 to toggle the in-store mode. For instance, the display user interface 500b includes a description 510b of the in-store mode and user interactive elements 520b and 530b for enabling or disabling the in-store mode, respectively. Upon the user 101 selecting the user interactive element 520b corresponding to enabling the in-store mode, the in-store mode is enabled. On the other hand, upon the user 101 selecting the user interactive element 530b corresponding to disabling the in-store mode, the in-store mode is disabled.

At 420, the geolocation circuit 208 determines whether the user device 210 is present at a branch location (including the branch location 110) of the financial institution 140 in the manner described. In response to determining that the user device 210 is not at any branch location of the financial institution 140 (420:NO), the method 400 returns to 420. On the other hand, in response to determining that the user device 210 is at a branch location (e.g., the branch location 110) (420:YES), the information exchange circuit 265 configures the input/output circuit 205 to display a notification indicating to the user 101 of the mobile device 210 that the user 101 is at the branch location 110 at 430.

FIG. 5C is a diagram of a display user interface 500c outputted by the input/output circuit 205 (FIG. 2) for notifying the user 101 that the user 101 is at the branch location 110 (at 430) according to various arrangements. Referring now to FIGS. 1-5C, a user interface aspect of the information exchange circuit 265 facilitates presentation of the display user interface 500c by the input/output circuit 205. In other arrangements, the banking client application 270 and/or the mobile wallet client application 280 can facilitate presentation of the display user interface 500c by the input/output circuit 205 (i.e., the display user interface 500c is a part of a banking client interface enabled by the banking client application 270 and/or a mobile wallet client interface enabled by the mobile wallet client application 280). The display interface 500c includes a pop-up message 510c indicating that the user 101 is at the branch location 110. Other suitable notification mechanisms such as, but not limited to, audio notifications, tactile notifications, or the like can be used.

At 440, the information exchange circuit 265 determines one or more of expected wait time and/or position in queue for the service requested or expected by the user 101. In some examples, the wait time and/or position in queue can be determined by the information exchange circuit 260 of the financial institution computing system 242 and sent via the communication network 202 to the user device 210. In other examples, the information exchange circuit 260 of the financial institution computing system 242 configures the network interface 248 to send one or more parameters relevant to the wait time and/or position in queue to the user device 210, and the information exchange circuit 265 determines the wait time and/or position in queue. The parameters relevant to the wait time and/or position in queue include, but not limited to, a number of customers in queue before the user 101, type of services requested by the customers in queue before the user 101, personnel capacity at the branch location 110, or the like.

The queue is stored in the memory 246 in some examples, and updated dynamically in the manner described. The queue can be organized based types of services expected in some arrangements. For instance, a first queue stored and maintained in the memory 246 can be a queue for customers who want/scheduled to see a teller while a second queue stored and maintained in the memory 246 can be a queue for customers who want/scheduled to see a banker. In some examples, the queue can be organized based on employees. For instance, a first queue can be a queue for customers who want/scheduled to see Banker X while a second queue can be a queue for customers who want/scheduled to see Advisor Y.

The information exchange circuit 260 receives or otherwise triggers a customer arrival indication message every time a customer (including the user 101) enters the branch location 110. In some arrangements, one or more customers entering the branch location 110 may have a device such as, but not limited to, the user device 210, which is capable of determining whether the user device 210 is present at a branch location (420). Upon determining that a particular user device associated with a particular user is present at the branch location, the customer arrival indication message is sent to the information exchange circuit 260 of the financial institution computing system 242 via the network 202. In some arrangements, an employee (e.g., the employees 120) can input the customer arrival indication message via an input system included in or associated with the financial institution computing system 242 as the customers enter the branch location 110. In some arrangements, a motion sensor at the branch location 110 can detect an entering customer and automatically triggers a customer arrival indication message as a response. In some arrangements, a customer arrival indication message is automatically triggered at appointment times reserved in advance by the customer who has made the appointment. Each customer arrival indication message is time-stamped. Thus, the customers entering the branch location 110 can be accordingly ranked by time of arrival based on the time-stamps, allowing a position in queue of the user 101 (the user device 210) to be determined. The number of customers in queue before the user 101 can be determined based on the customer arrival indication message.

Similar mechanisms can be implemented to determine customers leaving the queue, thus dynamically updating the queue. For example, upon determining that a particular user device associated with a particular user is no longer at the branch location based on geolocation mechanisms described herein, a customer departure indication message is sent to the information exchange circuit 260 of the financial institution computing system 242 via the network 202. In some arrangements, the employees 120 can input the customer departure indication message via the input system included in or associated with the financial institution computing system 242 as the customers leave the branch location 110. In some arrangements, a motion sensor at the branch location 110 can detect a departing customer and automatically triggers a customer departure indication message as a response. In some arrangements, a customer departure indication message is automatically triggered when the appointment times end. Updates of the queue (e.g., changes to the position in queue or estimated time) are sent by the network interface 248 to the user device 210.

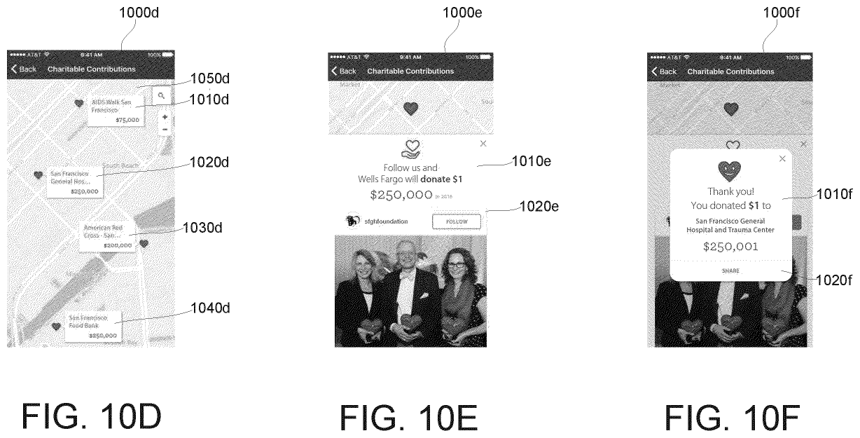

In some examples, the customers (e.g., the user 101) can indicate a requested service via a device such as the user device 210. Illustrating with a non-limiting example, the user 101 (as well as other customers) can input a requested service via the display user interfaces 1000a-1000c (FIGS. 10A-10C). In some arrangements, an employee (e.g., the employees 120) can input the requested services via an input system included in or associated with the financial institution computing system 242 after speaking to the customers. In some arrangements, the requested service is included as a part of an appointment scheduled for a customer. The memory 246 and/or the memory 204 may store an estimated (average) time mapped to each type of service. Based on such mapping, an estimated wait time for the customer(s) in queue before the user 101 can be determined.

The personnel capacity can reflect a number of employees (e.g., the employees 120) that are currently working and/or available. Increased personnel capacity can decrease the estimated wait time, vice versa. In some arrangements, the personnel capacity at the branch location 110 can be determined and updated based on one or more of an input by an employee (e.g., the employees 120) via an input system included in or associated with the financial institution computing system 242, a work schedule for the employees 120, scheduled appointments, or the like. The work schedule and the appointments are stored in the memory 204 or the memory 204.

At 450, the information exchange circuit 265 causes the input/output circuit 205 to display the expected wait time and/or the position in queue to the user 101. For example, the display user interfaces 800a, 900a-900d, and 1000a includes a portion that displays the expected wait time and/or the position in queue. The expected wait time and/or the position can be displayed in other user display interfaces as well. The expected wait time and/or the position in queue are displayed with other information related to or unrelated to the expected service in a same display user interface to remind the user 101 of the upcoming service.

At 460, the information exchange circuit 265 determines whether the user 101 has been serviced. In some arrangements, the user 101 can indicate whether he or she has been serviced via the input/output circuit 205. In some arrangements, one of the employees 120 who has serviced the user 101 can indicate such via an input system included in or associated with the financial institution computing system 242. In some arrangements, the user 101 is determined to be serviced in response to the geolocation circuit 208 determining that the user device 210 is no longer at the branch location 110 (e.g., the user device 210 moves from inside to outside of the boundary of the branch location 110).

In response to determining that the user 101 has been serviced (460:YES), the method 400 ends. A notification indicating that the user has been serviced may be displayed by the input/output circuit 205. On the other hand, in response to determining that the user 101 has not been serviced (460:NO), the information exchange circuit 265 causes the input/output circuit 205 to exchange information with the user 101, at 470. Exchanging information with the user 101 includes, but not limited to, displaying information related to the service at the branch location 110 at 472, receiving user input (from the user 101) related to the service at the branch location 110 at 474, displaying information unrelated to the service at the branch location 110 at 476, receiving user input (from the user 101) unrelated to the service at the branch location 110 at 478, or the like. The service at the branch location 110 refers to the service expected and/or requested by the user 101 in this instant visit to the branch location 110.

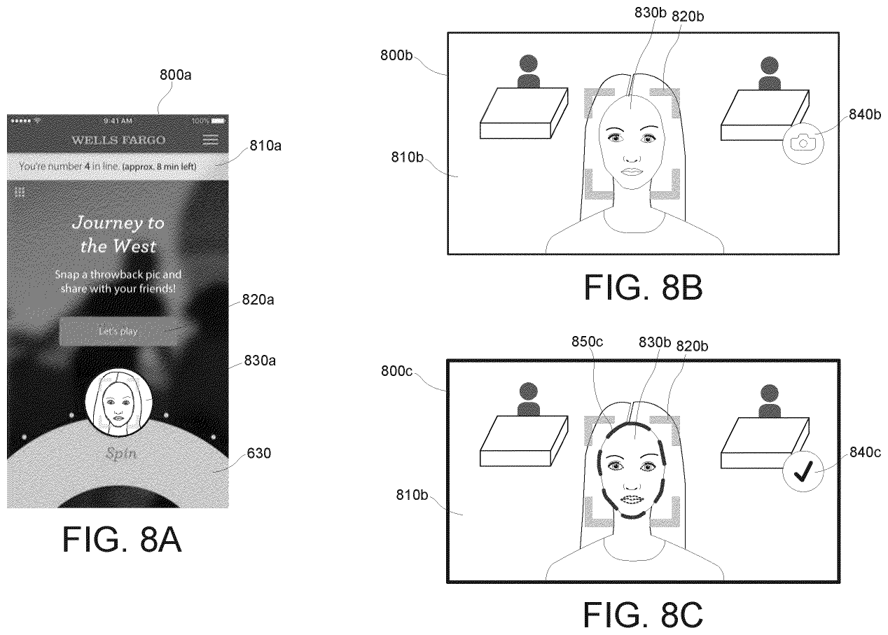

FIG. 6 is a diagram of a display user interface 600 outputted by the input/output circuit 205 (FIG. 2) of the user device 210 (FIG. 2) according to various arrangements. Referring now to FIGS. 1-6, a user interface aspect of the information exchange circuit 265 facilitates presentation of the display user interface 600 by the input/output circuit 205. In other arrangements, the banking client application 270 and/or the mobile wallet client application 280 can facilitate presentation of the display user interface 600 by the input/output circuit 205 (i.e., the display user interface 600 is a part of a banking client interface enabled by the banking client application 270 and/or a mobile wallet client interface enabled by the mobile wallet client application 280). The display user interface 600 presents options including (1) displaying information and/or receiving user input related to the service at the branch location 110; and (2) displaying information and/or receiving user input unrelated to the service at the branch location 110.

Information or user input related to the services includes information that can assist one of the employees 120 or a machine (e.g., an ATM) in rending the service requested by the customer. For example, the user input corresponding to the information related to the service may be transmitted from the user device 210 to the financial institution computing system 242, so that the employees 120 (who has access to the information stored on the financial institution computing system 242) can have such information before the service is actually rendered, thus conserving time. Indeed, the employees 120 or the machines do not need information that the user 101 has already provided while waiting for the service. As referred to herein, information or user input unrelated to the services are transmitted from the user device 210 to the financial institution computing system 242, and such information or user input is not used for rending the service for this instant visit. However, the information or user input unrelated to the services can be stored in the memory 246, account database 250, and/or mobile wallet database 252 for future use (e.g., for a future visit to the branch location 110).

The display user interface 600 includes a queue status indicator 610 that outputs the expected wait time and/or the position in queue to the user 101. The display user interface 600 may include a service-related user interactive element 620 that triggers additional display user interfaces to display information and/or receiving user input related to the service at the branch location 110 in response to being selected. In the non-limiting example shown in FIG. 6, the service-related user interactive element 620 is a drop-down menu including types of service that the user 101 can solicit from the branch location 110. The types of service include, but not limited to, opening an account, managing an account, withdrawing, depositing, speaking with a financial adviser, taking out a loan or mortgage, service by appoint (e.g., the user 101 has an appointment), and the like. The display user interface 600 may include a service-unrelated user interactive element 630 (e.g., a spin-dial) that triggers additional display user interfaces to display information and/or receiving user input unrelated to the service at the branch location 110 in response to being selected.

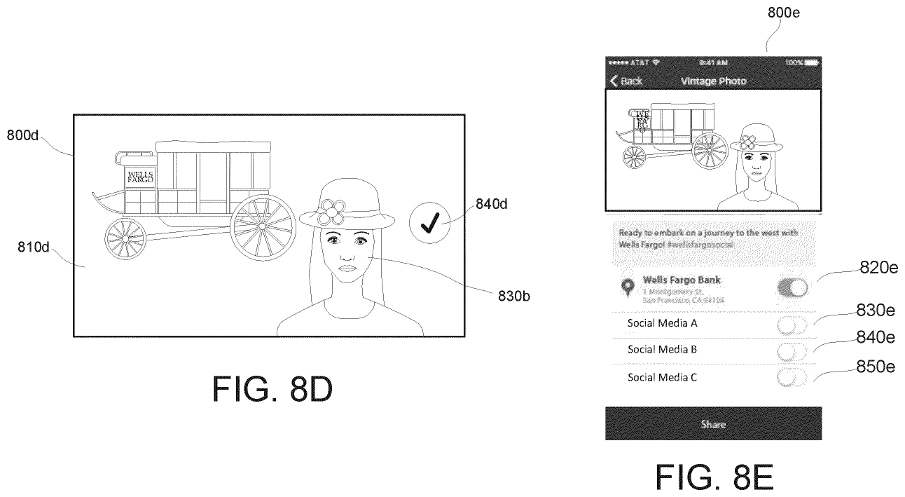

FIGS. 7A-7C are diagrams of display user interfaces 700a-700c outputted by the input/output circuit 205 (FIG. 2) of the user device 210 (FIG. 2) for exchanging information related to the service at the branch location 110 (FIG. 1) according to various arrangements. Referring now to FIGS. 1-7C, a user interface aspect of the information exchange circuit 265 facilitates presentation of the display user interfaces 700a-700c by the input/output circuit 205. In other arrangements, the banking client application 270 and/or the mobile wallet client application 280 can facilitate presentation of the display user interfaces 700a-700c by the input/output circuit 205 (i.e., the display user interfaces 700a-700c are parts of a banking client interface enabled by the banking client application 270 and/or a mobile wallet client interface enabled by the mobile wallet client application 280). The display user interfaces 700a-700c facilitate prestaging, which refers to displaying information and/or receiving user input related to the service at the branch location 110 (e.g., at 472 and 474).

The information exchange circuit 265 causes the input/output circuit 205 to present the display user interface 700a in response to a type of service (e.g., opening an account) being selected via the service-related user interactive element 620 of the display user interface 600 in some arrangements. The display user interface 700a includes information for or inquiries to the user 101 (e.g., inquiry elements 710a) concerning the expected service at the branch location 110. In the non-limiting example shown in FIG. 7A, the inquiry elements 710a request the user 101 to identify a category of accounts that the user 101 expects to open, and name and date of birth of the user. The display user interface 700a includes a user interactive element 720a (corresponding to selecting a saving account) and a user interactive element 730a (corresponding to selecting a checking account) indicating categories or subcategories of the service that the user 101 expects to open. The display user interface 700a includes a name field 740a for receiving a name of the user 101. The display user interface 700a includes a birthday field 750a for receiving a birthday of the user 101. The display user interface 700a further includes a confirmation element 760a to confirm data entered in the display user interface 700a and a termination element 770a to skip or terminate displaying or accepting user input via the display user interface 700a.

The display user interface 700b is the display user interface 700a with the name field 740a and the birthday field 750a filled, and the user interactive element 730a (corresponding to selecting a checking account) selected. The confirmation element 760a is selected to confirm the data entered. The display user interface 700c includes a pop-up window 710c displayed (e.g., superimposed) on the display user interface 700b. The pop-up window 710c includes a confirmation message indicating that the user 101 will receive a SMS message when at least one of the employees 120 is available to service the user 101. The information exchange circuit 260 configures the network interface 248 (having a SMS feature) to send the SMS to the user device 210.

In some arrangements, the information exchange circuit 260 determines that at least one of the employees 120 is available in response to receiving an availability indication from an input device included in or associated with the financial institution computing system 242. For instance, the at least one of the employees 120 uses the input device to indicate availability of himself/herself, or of another one of the employees 120. In some arrangements, the information exchange circuit 260 configures the network interface 248 to send the availability indication message to the user device 210 (e.g., the information exchange circuit 265), so that the information exchange circuit 265 can configure the input/output circuit 205 to notify the user 101 of the availability.

In some examples, the information and/or user input related to the service includes feedback of the user 101 after the service has been rendered. In response to determining that the service has been completed in the manner described, the information exchange circuit 265 presents display user interfaces to solicit user feedback concerning the service rendered. Once completed, the responses are transmitted via the communication network 202 to be stored in the memory 246.

As described herein, the user input related to the service includes a type of service that the user 101 expects to receive at the branch location 110. Based on such user input, the information exchange circuit 265 or the information exchange circuit 260 can identify a staff member of the financial institution 140 located in the branch location 110 or in another location other than the branch location 110. Illustrating with a non-limiting example, in response to determining that the user 101 expects equity/mortgage services, the information exchange circuit 265 or the information exchange circuit 260 determines whether the branch location 110 has a relevant staff. Information concerning the staff's schedules and associated expertise are stored on the memory 204 or 246 for lookup. In response to determining that no relevant staff is at the branch location 110, the information exchange circuit 265 or the information exchange circuit 260 can communicate with (e.g., send inquiry messages to) a computing system (similar to the financial institution computing system 242) associated with a relevant staff at another location. The information exchange circuit 265 or the information exchange circuit 260 can facilitate real-time assistance by enabling a conferencing feature (e.g., video conferencing, audio conferencing, or the like) enabled by the input/output circuit 205 so that the user 101 can communicate. In addition, the information exchange circuit 265 or the information exchange circuit 260 can facilitate making an appointment with that staff by communicating with the computing system associated therewith.

In some examples, the information and/or user input related to the service includes authentication information that can grant expedited service. The information exchange circuit 265 can configure the input/output circuit 205 to authenticate the user 101 via login credentials, biometrics, or the like. Once the user 101 is authenticated, a passcode, Quick Response (QR) code, and/or Near Field Communication (NFC) device is configured, with corresponding authentication (handshake) information sent the financial institution computing system 242 over the communication network 202. Upon the user device 210 interacting with an input terminal coupled to the financial institution computing system 242 at the branch location 110 with respect to the passcode, QR code, and/or NFC device, the user 101 is authenticated with the branch location 110 as well.

In some examples, the information and/or user input related to the service includes profiles (e.g., contact information) of the employees 120 about to service or has serviced the user 101. For instance, the information exchange circuit 265 or the information exchange circuit 260 matches one of the employees 120 with the user 101 based on user input indicating expected service. The profile information (stored on the memory 246) is transmitted to the user device 210 via the communication network 202. The information exchange circuit 265 can cause the profile information (e.g., a name, phone number, email address, schedules, availabilities, or the like) to be stored on the memory 204 (e.g., a phone book) of the user device 210.

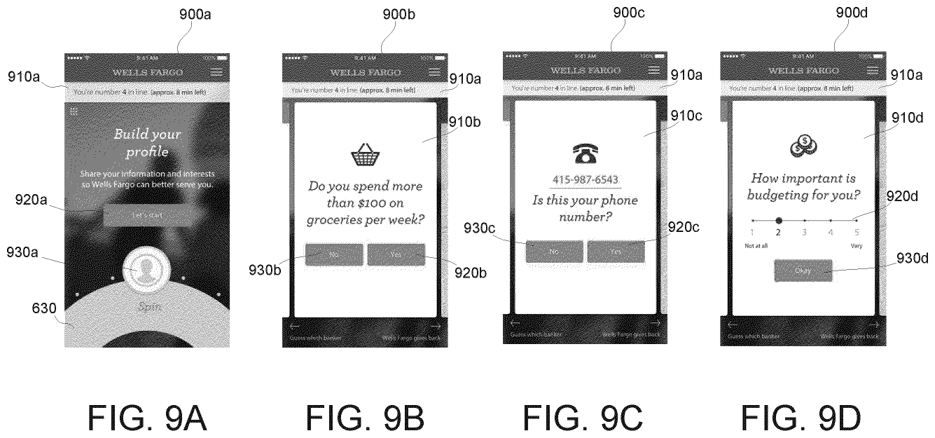

FIGS. 8A-8E are diagrams of display user interfaces 800a-800e outputted by the input/output circuit 205 (FIG. 2) of the user device 210 (FIG. 2) for exchanging information unrelated to the service at the branch location 110 (FIG. 1) according to various arrangements. Referring now to FIGS. 1-8E, a user interface aspect of the information exchange circuit 265 facilitates presentation of the display user interfaces 800a-800e by the input/output circuit 205. In other arrangements, the banking client application 270 and/or the mobile wallet client application 280 can facilitate presentation of the display user interfaces 800a-800e by the input/output circuit 205 (i.e., the display user interfaces 800a-800e are parts of a banking client interface enabled by the banking client application 270 and/or a mobile wallet client interface enabled by the mobile wallet client application 280). The display user interfaces 800a-800e present a photo manipulation feature that is unrelated to the service presently requested or expected at the branch location 110.

The display user interface 800a is displayed in response to selecting the photo manipulation feature element 830a with the service-unrelated user interactive element 630 (e.g., by spinning the spin-dial). The display user interface 800a includes a queue status indicator 810a that outputs to the user 101 the expected wait time and/or the position in queue. The display user interface 800a includes a confirmation element 820a confirming the selection.

The display user interface 800b includes a camera activator element 840b that configures a camera of the user device 210 to take a digital photograph. The digital photograph presented in the display user interface 800b includes a face feature 830b of the user 101. The face feature 830b is graphically identified with a feature frame 820b. Given that the digital photograph is taken in the branch location 110, a background 810b of the branch location 110 is present.

The display user interface 800c includes the background 810b, face feature 830b, and feature frame 820b of the display user interface 800b. Guidelines 850c are presented to show outlines of aspects of the face feature 830b. The camera activator element 840b becomes a confirmation element 840c in the display user interface 800c. In response to the confirmation element 840c being selected, the display user interfaces 800d is. The display user interfaces 800d includes the face feature 830b superimposed on a background picture 810d. The background picture 810d is different from the background 810b, which is a picture of the branch location 110. Upon selecting confirmation element 840d, a corresponding background 810d, is selected. Additional backgrounds different form the background 810d can be presented for selection.

For instance, the display user interface 800e is presented in response to the confirmation element 840d of the display user interface 800e being selected by the user 101. The picture shown in the display user interface 800e has the background 810d and the face feature 830b. A location toggle element 820e can allow the user 101 to select and/or confirm that the branch location 110 is to be posted on social media with the picture. The display user interface 800e includes social media elements 830e-850e that trigger the picture to be posted on the corresponding social media in response to being selected.

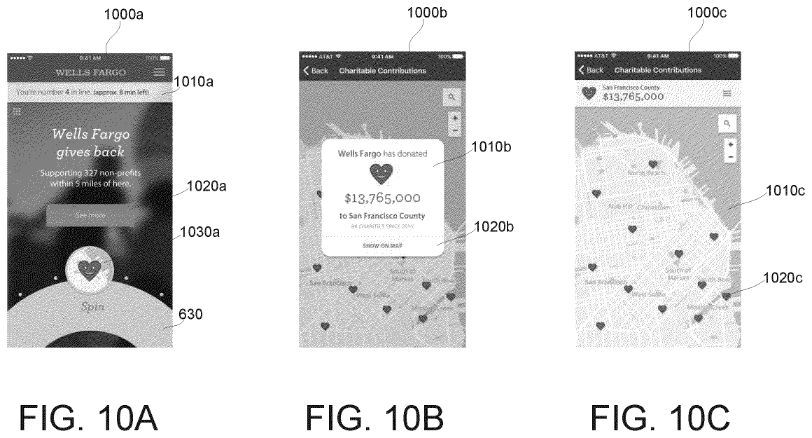

FIGS. 9A-9D are diagrams of display user interfaces 900a-900d outputted by the input/output circuit 205 (FIG. 2) of the user device 210 (FIG. 2) for exchanging information unrelated to the service at the branch location 110 (FIG. 1) according to various arrangements. Referring now to FIGS. 1-9D, a user interface aspect of the information exchange circuit 265 facilitates presentation of the display user interfaces 900a-900d by the input/output circuit 205. In other arrangements, the banking client application 270 and/or the mobile wallet client application 280 can facilitate presentation of the display user interfaces 900a-900d by the input/output circuit 205 (i.e., the display user interfaces 900a-900d are parts of a banking client interface enabled by the banking client application 270 and/or a mobile wallet client interface enabled by the mobile wallet client application 280). The display user interfaces 900a-900d allow the user 101 to build a financial profile that is unrelated to the service presently requested or expected at the branch location 110.

The display user interface 900a is displayed in response to selecting a profile building element 930a with the service-unrelated user interactive element 630 (e.g., by spinning the spin-dial). The display user interface 900a includes a queue status indicator 910a that outputs to the user 101 the expected wait time and/or the position in queue. The display user interface 900a includes a confirmation element 920a confirming the selection.

In response to the confirmation element 920a being selected, one or more of the display user interfaces 900b-900d are presented in any suitable sequence. Each of the display user interfaces 900b-900d includes the queue status indicator 910a. Each of the display user interfaces 900b-900d includes a financial inquiry 910b, 910c, or 910d, respectively, to which the user 101 is requested to respond via the input/output circuit 205. The financial inquiries 910b, 910c, and 910d relate to one or more of a spending habit, contact information, financial preferences, or the like. The input/output circuit 205 presents user interactive elements 920b, 930b, 920c, 930c, 920d, and 930d to obtain input from the user 101.

In some examples, information unrelated to the service at the branch location 110 includes financial advices (e.g., “Financial Tips for Teens”) for the user 101. The financial advices are stored in the memory 204 in some examples. In other examples, the financial advices are stored in the memory 246 and transmitted to the user device 210 via the communication network 102. The financial advices may be determined by the information exchange circuit 265 or 260 based on the user input received, for example, via the interfaces 900a-900d. The financial advices are displayed while the user 101 waits for the service.

Furthermore, the information related and unrelated to the service can be used for determining suitable offerings of financial products and services. For instance, the information received via the interfaces 900a-900d can be used by the information exchange circuit 265 or 260 to determine suitable offerings of financial products and services. In the case that the offers are determined by the information exchange circuit 260, the offerings can be sent via the communication network 102 to the user device 210.

FIGS. 10A-10F are diagrams of display user interfaces 1000a-1000f outputted by the input/output circuit 205 (FIG. 2) of the user device 210 (FIG. 2) for exchanging information unrelated to the service at the branch location 110 (FIG. 1) according to various arrangements. Referring now to FIGS. 1-10F, a user interface aspect of the information exchange circuit 265 facilitates presentation of the display user interfaces 1000a-1000f by the input/output circuit 205. In other arrangements, the banking client application 270 and/or the mobile wallet client application 280 can facilitate presentation of the display user interfaces 1000a-1000f by the input/output circuit 205 (i.e., the display user interfaces 1000a-1000f are parts of a banking client interface enabled by the banking client application 270 and/or a mobile wallet client interface enabled by the mobile wallet client application 280). The display user interfaces 1000a-1000f allows the user 101 to view charitable contributions of the financial institution 140 and/or allow the user 101 to contribute to the charitable effort.

The display user interface 1000a is displayed in response to selecting a community element 1030a with the service-unrelated user interactive element 630 (e.g., by spinning the spin-dial). The display user interface 1000a includes a queue status indicator 1010a that outputs to the user 101 the expected wait time and/or the position in queue. The display user interface 1000a includes a confirmation element 1020a confirming the selection.

In response to the confirmation element 1020a being selected, one or more of the display user interfaces 1000b-1000f are presented in any suitable sequence. The display user interface 1000b includes a message window 1010b showing a total charitable contribution of the financial institution 140 in a given geographical area (e.g., San Francisco Country). A map interactive element 1020b is presented in the display user interface 1000b that triggers displaying the display user interface 1000c in response to being selected. The display user interface 1000c includes a map 1010c of the geographical area for which the total charitable contribution is calculated. The map 1010c may include elements (e.g., an element 1020c) representing locations of charitable organizations with which the financial institution 140 has engaged charitable efforts. The display user interface 1000d includes a zoomed-in portion 1050d of the map 1010c. The portion 1050d includes display elements 1010d-1040d each corresponding to a location of an charitable organization. Each display element 1010d-1040d indicates a corresponding name of the identified charitable organization and an amount that the financial institution 140 has contributed thereto.

In response to one of the display elements 1010d-1040d (e.g., the display element 1020d) being selected by the user 101, the display user interface 1000e is displayed. The display user interface 1000e includes a window 1010e showing the name of the identified charitable organization and an amount that the financial institution 140 has contributed thereto. The window 1010e indicates that the financial institution 140 will contribute to the charitable cause of the charitable organization in response to the user 101 following the charitable organization on social media. The display user interface 1000e includes a social media element 1020e that triggers following of the charitable organization on social media in response to being selected.

In response to the social media element 1020e being selected, the display user interface 1000f is presented. The display user interface 1000f includes a confirmation message 1010f indicating that contribution has been made to the charitable organization. The display user interface 1000f includes a sharing element 1020f that, in response to being selected, triggers sharing of the interaction of the user 101 with the financial institution 140 and the charitable organization on social media.

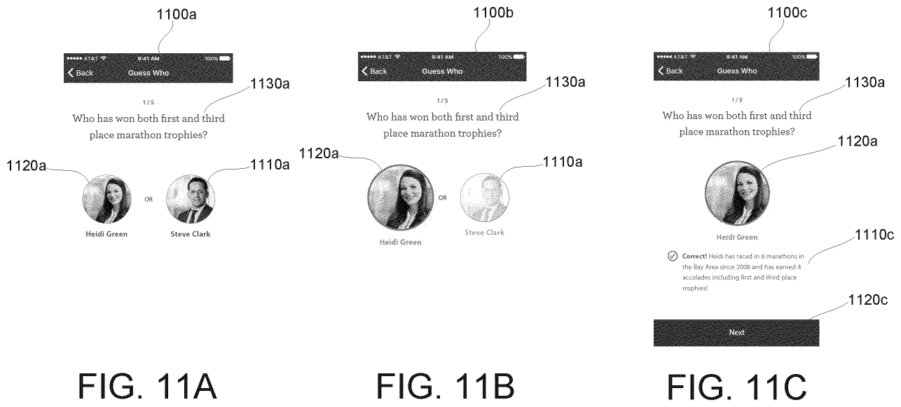

FIGS. 11A-11C are diagrams of display user interfaces 1100a-1100c outputted by the input/output circuit 205 (FIG. 2) of the user device 210 (FIG. 2) for exchanging information unrelated to the service at the branch location 110 (FIG. 1) according to various arrangements. Referring now to FIGS. 1-11C, a user interface aspect of the information exchange circuit 265 facilitates presentation of the display user interfaces 1100a-1100c by the input/output circuit 205. In other arrangements, the banking client application 270 and/or the mobile wallet client application 280 can facilitate presentation of the display user interfaces 1100a-1100c by the input/output circuit 205 (i.e., the display user interfaces 1100a-1100c are parts of a banking client interface enabled by the banking client application 270 and/or a mobile wallet client interface enabled by the mobile wallet client application 280). The display user interfaces 1100a-1100c allow the user 101 to engage in interactive activities to familiarize with the employees 120, the branch location 110, and/or the financial institution 140.

The display user interface 1100a is displayed in response to selecting a user interactive element (not shown) with the service-unrelated user interactive element 630 (e.g., by spinning the spin-dial). The display user interface 1100a includes a question interface 1130a that prompts an answer from the user 101. Option elements 1110a and 1120a are provided to for selection by the user 101. Questions in the question interface 1130a and the option elements 1110a and 1120a may be related to the employees 120, the branch location 110, and/or the financial institution 140. The display user interface 1100b is displayed as the user 101 selects the option element 1120a. The display user interface 1100c displays a correct answer 1110c to the question presented in the question interface 1130a.

In further scenarios, the branch location 110 is close to or within a merchant (e.g., a retail store, grocery store, supermarkets, or the like). In such scenarios, in response to detecting that the user device 210 is present at the branch location 110, displaying the information unrelated to the service at the branch location 110 (e.g., 320) includes presenting rewards, cash back, coupons, payment tokens, or the like electronically to the user 101 for shopping with the merchant.

In addition, the user input unrelated to the service at the branch location 110 includes user input concerning scheduling information for a subsequent appointment or a follow-up visit to the branch location 110 or another location of the financial institution 140. For example, the information exchange circuit 265 can cause the input/output circuit 205 to display user interfaces that prompt the user 101 to input availability for a subsequent appointment or a follow-up visit. Such information is then sent via the communication network 202 to the financial institution computing system 242 to be stored in the memory 246.

Furthermore, the information and/or user input unrelated to the service at the branch location 110 can correspond to an application for a loan calculator, financial planning, or another suitable financial tool. The tools presented are based on user input provided via the input/output circuit 205. For instance, in response to receiving user input indicating that the user 101 wishes to solicit a loan for this current visit, a loan calculator application is caused to be displayed in response to determining that the user device 210 is at the branch location 110.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method for presenting information to a user of a user device, comprising:
determining that the user device is present at a branch location of a financial institution based on a location of the user device being within a boundary associated with an area of the branch location;
in response to determining that the user device is present at the branch location, generating a first customer arrival indication message, establishing a communication connection with the user device, and causing the user device to display in-branch information comprising one or more of information related to service at the branch location or information unrelated to the service at the branch location;
time-stamping the first customer arrival indication message;
determining an expected wait time or a position in queue for the service based in part on available personnel at the branch location of the financial institution and on a comparison of the first customer arrival indication message timestamp to a plurality of time-stamps on a plurality of customer arrival indication messages, the plurality of customer arrival indication messages generated responsive to determining that at least one prior arriving user is present;
detecting that a prior arriving user is no longer present at the branch of the financial institution;
automatically updating, responsive to detecting that the prior arriving user is no longer present at the branch of the financial institution, the expected wait time;
displaying the expected wait time or the position in queue for the service as the information related to the service at the branch location;
receiving a user input corresponding to a financial tool;
displaying, on the user device, an application corresponding to the user input;
sending a message to the user device indicating that the service is ready to be rendered, the user device displaying one or more of the information related to the service or the information unrelated to the service before the user device receives the message; and
disabling the display of in-branch information as the service is rendered.

2. The method of claim 1, wherein determining that the user device is present at the branch location comprises determining that a geolocation of the user device is associated with the branch location.

3. The method of claim 2, further comprising determining the geolocation of the user device is determined using one or more of Global Positioning System (GPS), cell tower triangulation, or Wireless Fidelity (WiFi) Positioning System (WPS).

4. The method of claim 1, wherein the information related to the service at the branch location comprises at least one of prestaging information, wait time indication, scheduling information, customer feedback, or authentication.

5. The method of claim 1, wherein the information unrelated to the service at the branch location comprises at least one of charitable contributions by the financial institution, mobile application with a theme associated with the financial institution or the branch location, financial profile information, discounts, or financial health advices.

6. The method of claim 1, further comprising enabling an in-store mode on the user device based on user input, wherein the in-store mode supports displaying information related to the service at the branch location or displaying information unrelated to the service at the branch location.

7. The method of claim 1, further comprising displaying a notification to the user to indicate that the user is present at the branch location in response to determining that that the user device is present at the branch location.

8. (canceled)

9. The method of claim 1, wherein the information related to the service at the branch location or the information unrelated to the service at the branch location is displayed before the service is being rendered at the branch location.

10. The method of claim 1, further comprising:
determining whether to display the information related to the service at the branch location or display the information unrelated to the service at the branch location based on user input; and
displaying the information related to the service at the branch location or the information unrelated to the service at the branch location based on the user input.

11. The method of claim 1, further comprising receiving user input associated with the information related to the service at the branch location.

12. The method of claim 11, wherein the user input associated with the information related to the service at the branch location comprises information concerning at least one of a type of account that the user expects to open, name of the user, birthday of the user, or authentication information of the user.

13. The method of claim 1, further comprising receiving user input associated with the information unrelated to the service at the branch location.

14. The method of claim 13, wherein the user input associated with the information unrelated to the service at the branch location comprises information concerning a financial profile of the user.

15. A computing system, comprising:
a network interface structured to facilitate data communication via a network;
a memory; and
a processing circuit comprising a processor, the processing circuit configured to:
determine that a user device of a user is present at a branch location of a financial institution based on a location of the user device being within a boundary associated with an area of the branch location;
in response to determining that the user device is present at the branch location, generate a first customer arrival indication message, establish a communication connection with the user device, and cause the user device to display in-branch information comprising one or more of information related to service at the branch location or information unrelated to the service at the branch location;
time-stamp the first customer arrival indication message
determine an expected wait time or a position in queue for the service based in part on available personnel at the branch location of the financial institution and on a comparison of the first customer arrival indication message timestamp to a plurality of time-stamps on a plurality of customer arrival indication messages, the plurality of customer arrival indication messages generated responsive to determining that at least one prior arriving user is present;
detect that a prior arriving user is no longer present at the branch of the financial institution;
automatically update, responsive to detecting that the prior arriving user is no longer present at the branch of the financial institution, the expected wait time;
display the expected wait time or the position in queue for the service as the information related to the service at the branch location;
receive a user input corresponding to a financial tool;
displaying, on the user device, an application corresponding to the user input;
send a message to the user device indicating that the service is ready to be rendered, the user device displaying one or more of the information related to the service or the information unrelated to the service before the user device receives the message; and
disable the display of in-branch information as the service is rendered.

16. A non-transitory processor-readable medium having processor-readable instructions stored thereon, such that when executed by a processor of a computing device, the processor is configured to:
determine that a user device of a user is present at a branch location of a financial institution based on a location of the user device being within a boundary associated with an area of the branch location;
in response to determining that the user device is present at the branch location, generate a first customer arrival indication message, establish a communication connection with the user device, and cause the user device to display in-branch information comprising one or more of information related to service at the branch location or displaying information unrelated to the service at the branch location;
time-stamp the first customer arrival indication message;
determine an expected wait time or a position in queue for the service based in part on available personnel at the branch location of the financial institution and on a comparison of the first customer arrival indication message timestamp to a plurality of time-stamps on a plurality of customer arrival indication messages, the plurality of customer arrival indication messages generated responsive to determining that at least one prior arriving user is present;
detect that a prior arriving user is no longer present at the branch of the financial institution;
automatically update, responsive to detecting that the prior arriving user is no longer present at the branch of the financial institution, the expected wait time;
display the expected wait time or the position in queue for the service as the information related to the service at the branch location;
receive a user input corresponding to a financial tool;
display, on the user device, the application corresponding to the user input;
send a message to the user device indicating that the service is ready to be rendered, the user device displaying one or more of the information related to the service or the information unrelated to the service before the user device receives the message; and
disable the display of in-branch information as the service is rendered.

17. (canceled)

18. (canceled)

19. (canceled)

20. (canceled)

21. (canceled)

22. The method of claim 1, wherein the message is an availability indication message indicating an availability of an employee of the branch to provide the service.

23. The method of claim 1, wherein the estimated wait time or the position in the queue for the service is automatically updated in response to determining that a prior arriving user is no longer present at the branch of the financial institution.

24. The method of claim 1, wherein the determination of the estimated wait time or the position in the queue for the service is particularized to a service provider at the branch location of the financial institution.

25. (canceled)

26. The method of claim 1, further comprising:
displaying, on the user device, rewards, cash back, coupons, and/or payment tokens relating to shopping with the merchant.

27. The method of claim 1, further comprising:
displaying, on the user device, scheduling information relating to a follow-up visit to the branch location or another location of the financial institution; and
receiving a user input corresponding to the scheduling information.

28. The method of claim 1, further comprising:
displaying, on the user device, a picture of the user; and
responsive to receiving a confirmation input, posting the picture on a corresponding social media.

29. The method of claim 1, further comprising:
receiving a user input, wherein the user input corresponds to engagement in interactive activities corresponding to familiarization with employees, the branch location, and/or the financial institution.

30. The method of claim 1, further comprising:
displaying, on the user device, at least one charitable contribution of the financial institution; and
receiving a user input corresponding to a contribution to a charitable effort corresponding to the at least one charitable contribution.
